(19) United States
(12) Patent Application Publication
(10) Pub. No.: US 2019/0251551 A1
(43) Pub. Date: Aug. 15, 2019

(54) SYSTEMS, APPARATUSES, AND METHODS FOR ASSESSING, MANAGING, PRESENTING AND INDICATING THE VALUE OF A SET OF DIGITAL ASSETS

(71) Applicant: Blockchain Goose Inc., San Jose, CA (US)

(72) Inventor: Kianoosh MOUSAVI, San Jose, CA (US)

(21) Appl. No.: 16/270,326

(22) Filed: Feb. 7, 2019

Related U.S. Application Data
(60) Provisional application No. 62/630,485, filed on Feb. 14, 2018.

(51) Int. Cl. G06Q 20/36; H04L 9/30; H04L 9/06

(52) U.S. Cl. CPC G06Q 20/367; H04L 9/0643; H04L 9/30

(57) ABSTRACT

Apparatuses and methods for physically holding, presenting, and/or displaying the value of a set of digital or virtual assets or currencies it represents. It may include a human interface to physically present and/or display the value of at least one set of digital asset or currency the apparatuses represent. The apparatuses may include a set of logical circuits coupled with a specialized memory to temporary or permanently store the digital assets and/or currencies information and determine the display variation of their worth on the human interface based on their type and amount. The apparatuses may also include a set of connectors to access the sources of the digital assets and update the value the apparatuses represent. The apparatuses may also include a power source to power and enable the capabilities mentioned above.

### CROSS-REFERENCE TO RELATED APPLICATIONS

This application claims priority to applicant's co-pending U.S. Provisional Application No. 62/630,485 titled “System and Method for Representing the Value of Digital Assets Through Physical Objects,” filed Feb. 14, 2018, which is incorporated herein by reference in its entirety.

### FIELD OF DISCLOSURE

This disclosure relates in general to digital assets, and in particular to an apparatus for presenting the value of a set of digital assets.

### BACKGROUND

In general, there are individuals who enjoy the conspicuous display of items with intrinsic value, such as gold or diamonds.

Conspicuous consumption is generally spending of money on and the acquiring of luxury goods and services to publicly display accumulated wealth of the buyer. Often this display is a means of either attaining or maintaining a given social status.

A digital asset, such as cryptocurrency, is generally designed to work as a medium of exchange or storage of value that uses strong cryptography to secure financial transactions, control the creation of additional units, and verify the transfer of assets. However, because it is digital, it generally lacks a physical manifestation that can be conspicuously displayed.

“Scarcity” of a physical object, such as gold or diamonds, contributes to the object's value; the same applies to the digital currencies, such as cryptocurrency. However the abstract nature of the currencies make it impossible to present them the same way. Therefore, uniquely imbuing a physical object with these currencies allows the uniqueness and value to be added and presented in a similar manner to a jewelry piece.

In view of the foregoing, it would be beneficial to provide an apparatus in which the value of a set of digital assets may be conspicuously presented to another party.

### SUMMARY

Aspects of the present disclosure relate, in one embodiment, to an apparatus that presents the value of a set of digital assets. The apparatus includes a human interface configured to present the value of at least one digital asset of the set of digital assets. The apparatus also includes a set of logic circuits coupled to the human interface. The apparatus further includes a set of connectors, logically coupled to the set of logic circuits, wherein at least one connector, of the set of connectors, couples the digital wallet to the set of logic circuits; and a power source electrically coupled to the set of logic circuits.

Additional advantages and novel features of these aspects will be set forth in part in the description that follows, and in part will become more apparent to those skilled in the art upon examination of the following or upon learning by practice of the disclosure

### BRIEF DESCRIPTION OF THE DRAWINGS

Aspects of the present disclosure are illustrated by way of example, and not by way of limitation, in the figures of the accompanying drawings and in which like reference numerals refer to similar elements and in which:

FIG. 1 shows a schematic illustration of the apparatus, in accordance with aspects of the present disclosure;

FIG. 2 shows a more detailed illustration of a display in the apparatus, in accordance with aspects of the present disclosure;

FIG. 3 shows a user interactions with the apparatus and a simplified process flow schematic with an apparatus in accordance with aspects of the present disclosure;

FIG. 4 shows the simplified process flow of FIG. 3 in which a new digital asset address is added to an apparatus and verified, in accordance with aspects of the present disclosure;

FIG. 5 shows a process for generating a new digital asset address from a public key, in accordance with aspects of the present disclosure;

FIG. 6 shows a simplified logical diagram of an apparatus, in accordance with aspects of the present disclosure;

FIG. 7 shows a one-way hash function that may be used with digital assets such as Bitcoin, in accordance with aspects of the present disclosure;

FIG. 8 shows an example of a crypto private key and public address, in accordance with the aspects of the present disclosure;

FIG. 9 shows some specialized Read Only Memory (ROM) or Programmable Read Only Memory (PROM) or One Time Programmable Read Only Memory (OTP) to hold the private key along side a specialized microcontroller to calculate the public address and a driver to calculate the display value and a Random Access Memory (RAM) to store the values and corresponding dates, for use in accordance with aspects of the present disclosure;

FIG. 10 shows various features of a computer system for use in conjunction with aspects of the present disclosure; and

FIG. 11 shows an example computer system for use in conjunction with aspects of the present disclosure.

### DETAILED DESCRIPTION

Aspects of the present disclosure will now be described in detail with reference to a few preferred embodiments thereof as illustrated in the accompanying drawings. In the following description, numerous specific details are set forth in order to provide a thorough understanding thereof. It will be apparent, however, to one skilled in the art, that aspects of the present disclosure may be practiced without some or all of these specific details. In other instances, well known process steps and/or structures have not been described in detail in order to not unnecessarily obscure description thereof.

In general, it is difficult to conspicuously present a set of digital assets because it generally lacks a physical manifestation.

It is also difficult to uniquely imbue a physical object with the value of digital assets due to the abstract nature of those assets and the ability of the assets to be accessed on any digital device

In an advantageous manner, an apparatus may be configured, such that the value of a set of digital assets such as cryptocurrency, stored within the apparatus, or accessible by the apparatus, may be conspicuously presented to, for example, another party, wherein the other party may learn of the economic value of the presented set of digital assets.

In one embodiment, the value of a digital asset, such as cryptocurrency, may be conveyed through an outward visual or aural representation on the apparatus, wherein the representation may be an indication of the type of asset, the amount of the asset, the value of the asset, whether the value is increasing or decreasing, and other characteristics of the asset represented by or held on the apparatus.

In another embodiment, the apparatus stores a digital asset, such as cryptocurrency, and visually or aurally represents the value of that digital asset by use, for example, of color, sign, symbol, brightness or intensity of glow, text, sound, vibrations or other haptic component, or by any other perceptible feature. The represented value may be periodically updated by the apparatus after a specified duration.

In yet another embodiment, the apparatus may be connected through a network, such as the Internet or an intranet, to a digital asset account, enabling the value of the account to be visually or aurally represented in real time. In such embodiment, the apparatus may be used to monitor the transactions occurring in the connected digital account, or the market fluctuation of the digital currency's then current value, or the rate of change of values in the account and visually display the result.

In another embodiment, the value can be different types of currency or assets (not just digital), such as stocks, mutual funds, real estate holdings, savings accounts, bonds, trusts, or other types of securities or instruments.

In another embodiment, an externally inaccessible private key is permanently and securely embedded into the apparatus. The inaccessibility of the private key may ensure that any currency transferred to a public address associated with that private key will remain permanently locked in the apparatus and will not be retrievable. In such embodiment, the value of the apparatus can only be increased through the inbound transfer of cryptocurrency to the public key, such that the apparatus would have a face value like cash, bearer bonds, or other traditional negotiable instruments. By trapping the private key in a physical object the scarcity and value of the virtual or digital currency or assets imbues the object with value and therefore solves the problem of translating abstract crypto or digital-value into a physical object.

In yet another embodiment, the apparatus can be different types of jewelry or wearable, such as a bracelet, necklace, watch, ring, pendant, key chain, arm band, etc.

In summary, much like adding more diamonds to a pendant not only increases its value but also shows that increased value by shining more, adding more digital currency or digital asset to the apparatus increases its value and change its appearance to show that value increase. A one-carat diamond ring certainly shines more than one with a half-carat, an apparatus representing 1 bitcoin for example glows more than one with 0.1 bitcon, such that viewers can tell the difference in their values.

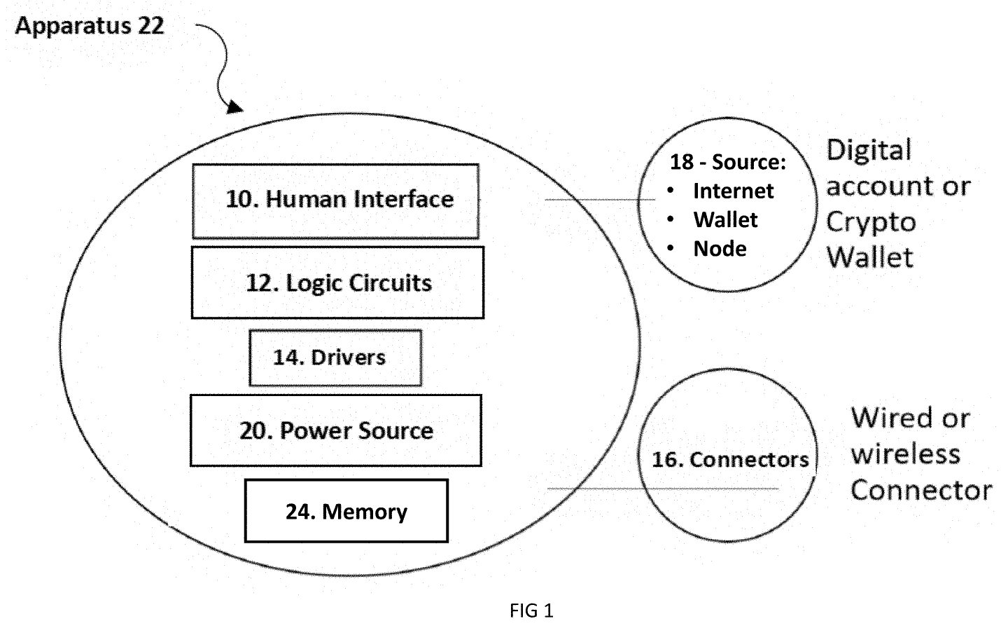

In yet another embodiment, the apparatus can hold other immutable values besides currency or assets, such as overall health score, social media status, or GPA for students. Referring to FIG. 1, a simplified representative schematic of apparatus 22 that allows the value of a set of digital assets, such as cryptocurrency, the private key of which is stored therein, may be conspicuously presented, in accordance with aspects of the present disclosure. The apparatus may connect via a network, for example, to an internal or external cryptocurrency or other digital currency wallet or account, which may serve as the source of the asset, and the value of the asset, visually represented on the apparatus. A Specialized Logic Circuit 12 comprised of Read Only Memory (ROM) or Programmable Read Only Memory (PROM) or One Time Programmable Read Only Memory (OTP) to hold the private key may operate within or alongside a specialized microcontroller to calculate the public address and a driver to calculate the display value and a Random Access Memory (RAM) to store the values and corresponding dates.

In general, the apparatus may be comprised of a human interface 10, a set of logic circuits 12 electrically coupled to human interface 10, a set of drivers 14 configured to couple the set of logic circuits 12 to a set of digital wallets 18, and power source 20 electrically coupled to the set of logic circuits 12.

In one embodiment, human interface 10 comprises a display. In general, “display” means any electronic component that transmits a visually or otherwise perceptible (e.g., audible or tactile) indication corresponding to information, including without limitation one or more of a set of light-emitting diodes (LED), organic light-emitting diodes (OLED), liquid crystal display (LCD) screens, electronic ink or electronic paper displays, a speaker, or other visual or other indicators.

In another embodiment, human interface 10 comprises a set of non-visual indicators, such as an audio speaker, piezo electric element or other type of vibration feature, or other types of non-visual displays or indicators.

The set of logic circuits 12 may further comprise hardware, firmware, or software, for example, that may calculate and enforce or otherwise utilize an algorithm configured to translate the value of a set of digital assets in digital wallet 18 into a visual or non-visual representation through the human interface 10. The digital wallet maybe comprised of one or more of a Read Only Memory (ROM), Programmable Read Only Memory (PROM), One Time Programmable Read Only Memory (OTP) to hold the private key, a specialized microcontroller to calculate the public address, a driver to calculate the display value and a Random Access Memory (RAM) to store the values and corresponding dates.

In another embodiment, human interface 10 may display text or symbols. In yet another embodiment, human interface 10 may transmit a light that comprises at least one of glowing, flashing, pulsing, vibrating, color-changing in intensity, color changing in hue, fading, and brightening.

In yet another embodiment, human interface 10 is configured to display at least one of a video, animation, image, and other audiovisual and visual work.

In another embodiment, the apparatus may emit sounds, vibrations, pulses, or other non-visual auditory or kinetic indicators of a certain type or amount of an asset or change in the asset's value. Much like visual indicators, these other auditory or kinetic indicators can be used to display a certain type of asset or amount of asset, or any changes in the asset's value.

Power source 20 may comprise a single use battery, a rechargeable battery, a photo-voltaic cell, a solar battery, a heat battery, a motion generator, and a manual generator.

In another embodiment, the apparatus may comprise a set of drivers 14, logically configured to securely store and present information associated with a set of digital assets (not shown), such as cryptocurrency. The information may include an associated public key and a present value.

In another embodiment, the apparatus may comprise a set of digital wallets 18, stored within the apparatus. In yet another embodiment, the apparatus may also include a set of connectors 16, wherein a connector of the set of connectors comprises a wireless and/or wired connector, operatively coupled to the set of logic circuits 12, and configured to logically connect the apparatus to a set of digital wallets 18, stored remotely from the apparatus.

The set of digital wallets 18 may further be configured with at least one of an internal wallet (physically within apparatus 22), an Internet coupled external wallet (also interchangeably referred to herein as a “Hot Wallet”), and/or a non-Internet coupled external wallet (also interchangeably referred to herein as a “Cold Wallet”). The set of external digital wallets may further comprise software, firmware, and/or hardware configured to store digital asset information, such as such as a computer, smart telephone or tablet, or other hardware.

In one embodiment, a connector from the set of connectors 16 may also be used to recharge the apparatus.

In another embodiment, a discrete amount of a digital asset, such as cryptocurrency, may be transferred to and stored on the apparatus 22, such as by transferring a balance of cryptocurrency from a digital wallet 18 or other account (not shown in FIG. 1).

In another embodiment, in contrast to transferring the digital asset to the apparatus, the value of the digital asset, not stored within the apparatus 22, may be represented through human interface 10 for a discrete period of time, before human interface 10 is refreshed to reflect the cryptocurrency's then current value.

In yet another embodiment, the apparatus may store and represent other types of digital assets not stored within apparatus 22, such as investment accounts (e.g., stock holdings and other types of securities or instruments).

In yet another embodiment, human interface 10 may display alphanumeric text or symbols. In another embodiment, human interface 10 may display a set of lights

In yet another embodiment, the human interface 10 may comprise a set of lights that may glow, flash, pulse, vibrate, emit sound, change color, fade in or out, or otherwise change in brightness, intensity, or hue.

In yet another embodiment, the human interface 10 may show a video, animation, image, or other audiovisual work.

In another embodiment the apparatus may emit sounds, vibrations, pulses, or other non-visual auditory or kinetic indicators of a certain type or amount of an asset or change in the asset's value. Much like visual indicators, these other auditory or kinetic indicators can be used to display a certain type of asset or amount of asset, or any changes in the asset's value.

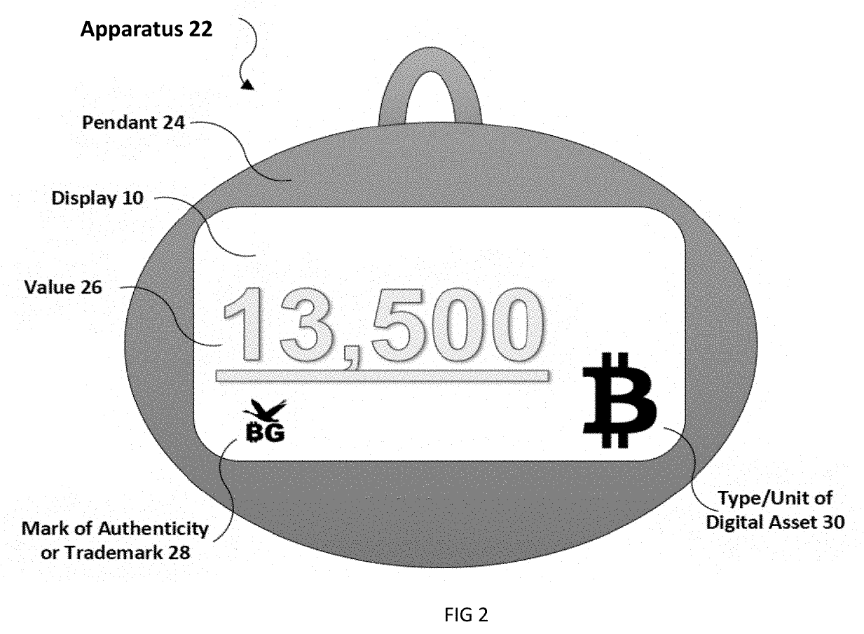

Referring to FIG. 2, a simplified diagram of one embodiment of the apparatus 22 is shown, in accordance with aspects of the present disclosure. In this configuration, the apparatus may be configured as a pendant 24 that may be prominently suspended round the neck of a wearer. Positioned on one face of pendant 24 may be a human interface, such as a display 10, configured to display text or symbols.

In another embodiment, the apparatus can be different types of jewelry or other wearable, such as a bracelet, necklace, watch, ring, pendant, key chain, arm band, etc.

In this example, value 26 of the digital asset may be displayed, along with the type or unit 30 of the digital asset, here Bitcoin. In addition, a symbol 28 may be displayed, presenting a mark of authenticity of the digital asset, or a trademark of the organization that manages, controls, or stores the digital asset.

A specialized microcontroller may be utilized to calculate the proper value of the display in accordance with the corresponding value the apparatus holds or represents. An example would be that the display glows blue for values within 10s of bitcoin, red for values in 100s, and Purple for values within 1000s of bitcoins. Furthermore, the intensity of the light may change within the range of each color, in accordance with the values of bitcoin the apparatus represent. In another example, the display may change intensity and color in a periodic, dynamic, or rhythmic manner (pulse) to denote even higher values such as 10,000s of bitcons.

In another example, the color of the display may represent the type of digital asset (e.g., orange for Bitcoin, purple for Ethereum, gray for litecoin, or the symbol of the asset along with a value of the asset). For example, the display may switch between different currencies stored within the apparatus and/or accessible by the apparatus. In addition, the display may mix and match various digital assets stored within the apparatus and/or accessible by the apparatus, and thus, may result in a unique representation of the various digital assets. In another example, different apparatus may be used for different types of digitals assets. The intensity, shine, and/or flashing may present the value of the digital asset (e.g., every 100 coin increases the intensity by one degree of illumination, and above 100,000 coin, the light may twinkle, shimmer or flash).

This approach allows the apparatus to be a physical representation of a virtual, digital or crypto currency or asset and uniquely apply the scarcity of the values it holds or represents to the physical object.

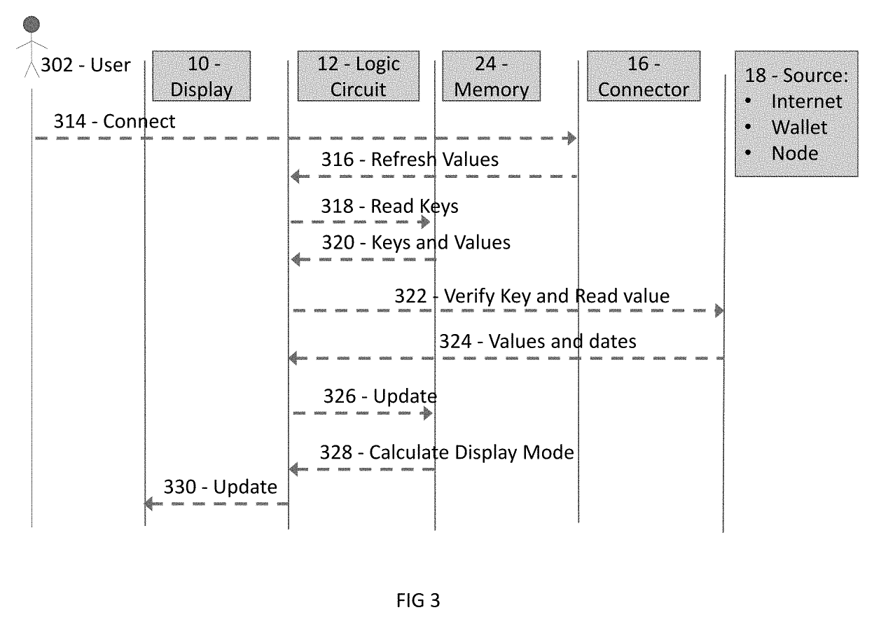

Referring to FIG. 3, a simplified process flow schematic that may be carried out by apparatus 22 of FIGS. 1 and 2 is shown, in accordance with aspects of the present disclosure. Initially, a user 302 connects the apparatus 22 (FIG. 1) to the source 18 (FIG. 1) in step 314 via connector 16 (FIG. 1), which maybe or include either a wired or a wireless connector, for example, coupled to one or more of the source 18 (FIG. 1) to read current values for the account, which in turn, connects to local memory 24 (FIG. 1).

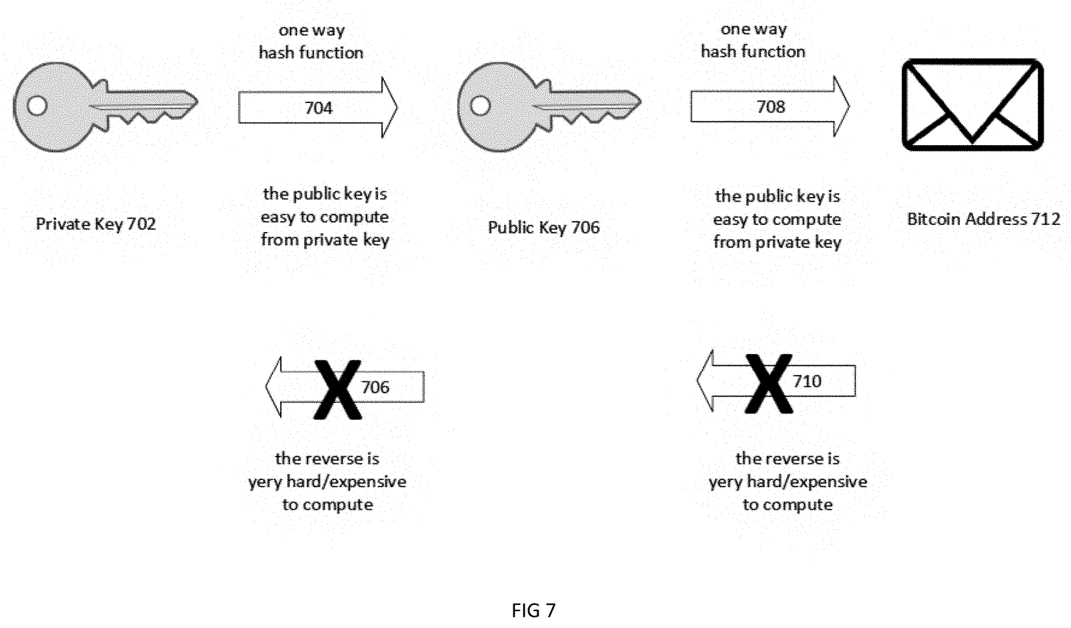

Digital asset data is then transferred in step 316 from local memory 24 (FIG. 1) to logic circuit 12 (FIG. 1), which in turn, reads one or more of the keys 702 and 706 (FIG. 7) from local memory 24 (FIG. 1) associated with the previously retrieved values in step 318. The Public Key 706 (FIG. 7) and associated public address 712 (FIG. 7) are used to receive values or verify the latest transactions to the account.

The keys and values are then transmitted in in step 320 to logic circuit 12 (FIG. 1).

The key and the previously read value may be transmitted to connector 16 (FIG. 1), which in turn connects to the digital asset data source 18 (FIG. 1), which may be located at one of a server or other device on the Internet, a digital asset wallet, or a digital asset node, for example, via step 322. Logical circuit 12 (FIG. 1) may perform verifications to validate the values, dates and authenticity of the data.

Verified values and dates are then transmitted back to display 10 (FIGS. 1 and 2) in step 324. Memory 24 (FIG. 1) is then updated by logic circuit 12 (FIG. 1) in step 326. Where the Memory 24 (FIG. 1) may be comprised of at one or more of a specialized Read Only Memory (ROM), Programmable Read Only Memory (PROM), One Time Programmable Read Only Memory (OTP) to hold the private key along and a Random Access Memory (RAM) to store the updated values and corresponding dates.

The display mode is then calculated in step 328, and the update is finally updated in step 330.

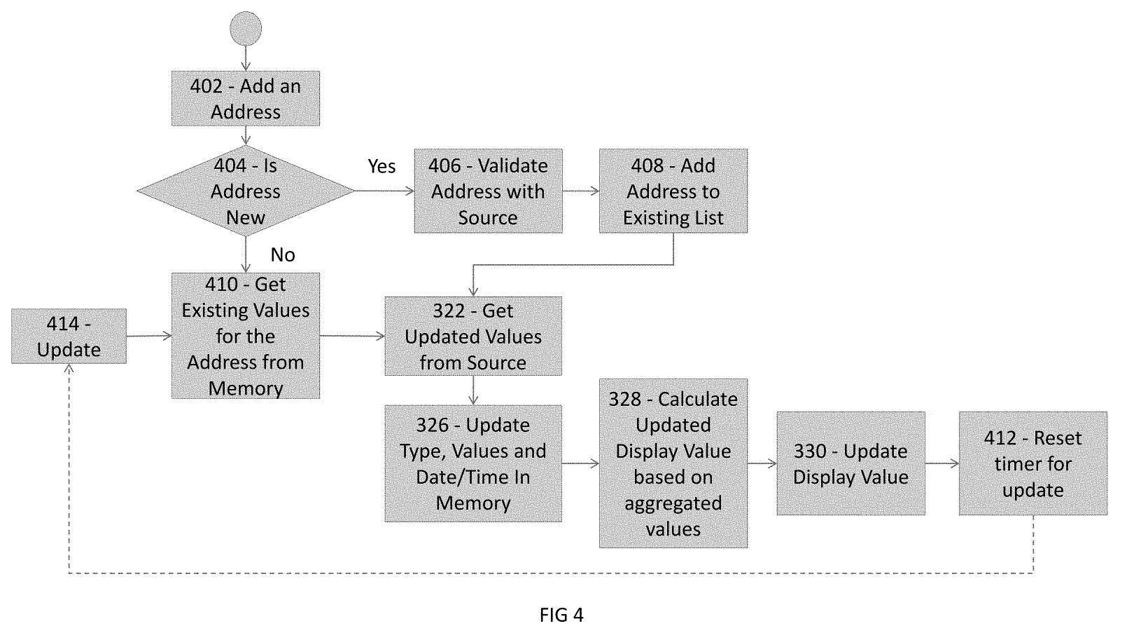

Referring now to FIG. 4, another representative flow diagram of the simplified process flow of FIG. 3 is shown, in which a new digital asset address is added to apparatus 22 (FIG. 1) and verified, in accordance with aspects of the present disclosure. Initially at step 402, a digital asset address is added to a memory 24 (FIG. 1) of apparatus 22 (FIGS. 1 and 2). Next at step 404, apparatus 22 (FIGS. 1 and 2) determines if the digital asset address is new.

If the digital asset address is new, the digital asset address is validated with the source of the digital asset address at step 406. The source may be, for example, accessible via the Internet and/or include a full or partial node, or a digital wallet.

The digital asset address is then added to an existing list in the memory on apparatus 22 (FIGS. 1 and 2). Apparatus 22 (FIGS. 1 and 2) then gets updated values from the digital asset address source as previously described.

If the digital asset address is not new, apparatus 22 (FIGS. 1 and 2) receives existing values for the digital asset address from the memory (not shown) at step 410. As previously described, apparatus 22 (FIGS. 1 and 2) then gets updated values from the digital asset address source at step 322. Apparatus 22 (FIGS. 1 and 2) then updates the type, values and date/time in memory 326.

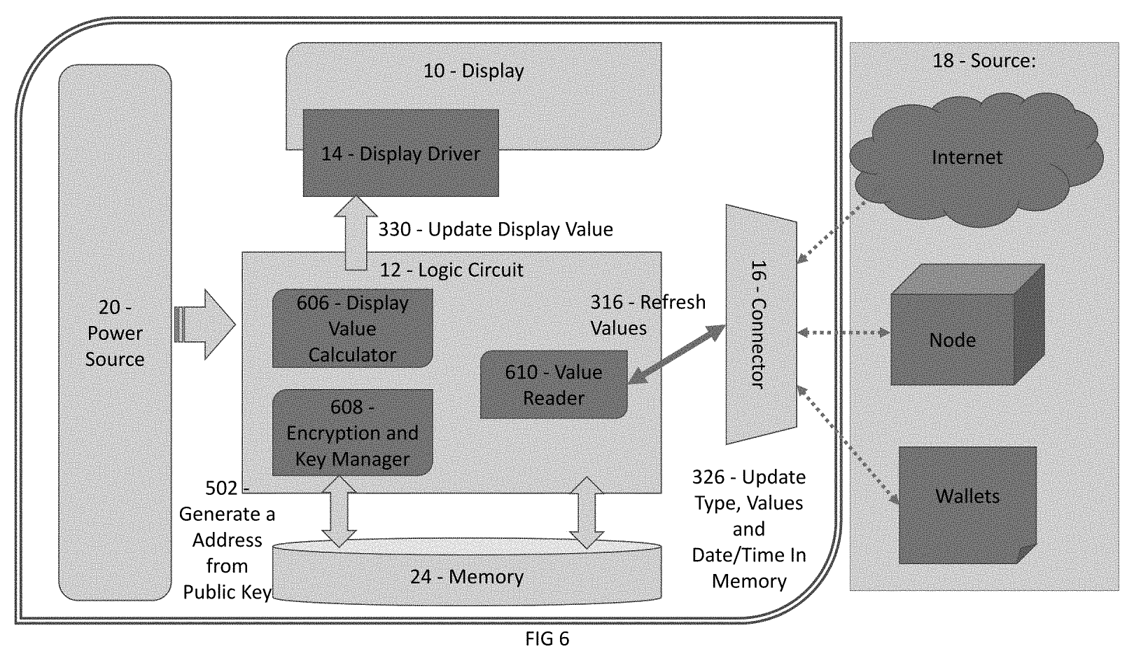

The display value is then calculated at 328 based on aggregate values through specialized Logic Circuit 12 (FIG. 1) comprised of the Memory 24 (FIG. 1) and Display Value Calculator 606 (FIG. 6).

The updated value is then displayed in human interface 10 (FIGS. 1 and 2) at step 330. The updated value may be displayed by any or all of the indicators described above, e.g., light, vibration, sound, etc.

Finally, an update timer in apparatus 22 (FIGS. 1 and 2) is reset at step 412.

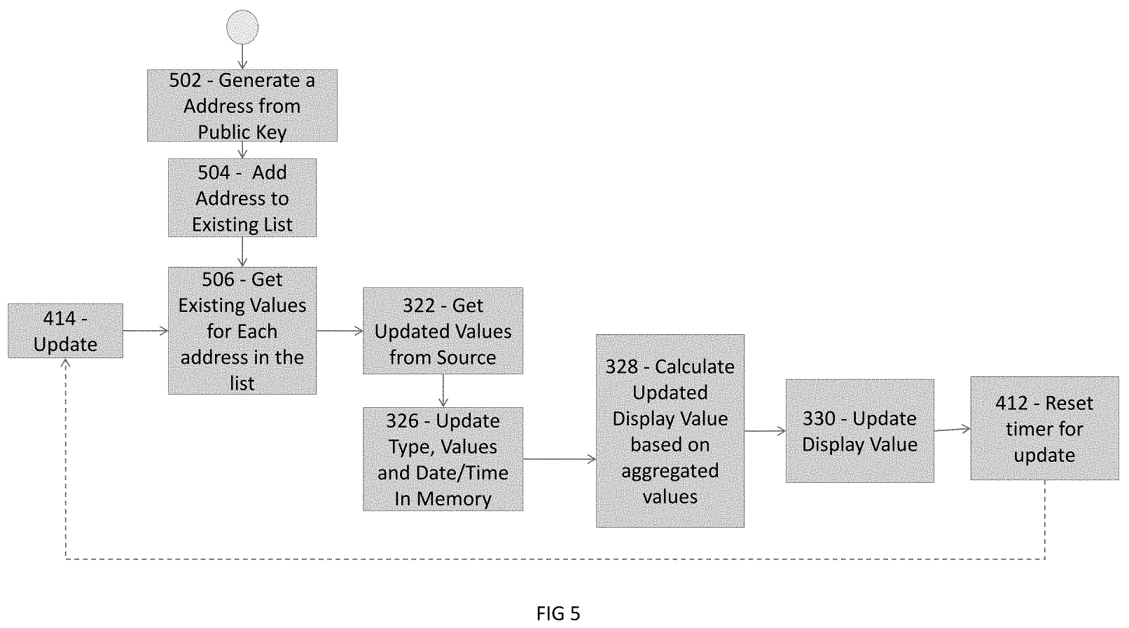

Referring now to FIG. 5, a process for updating a set of values of apparatus 22 (FIGS. 1 and 2) from a source with an address generated from a public key is shown, in accordance with aspects of the present disclosure.

Initially, a digital source address is generated from a public key (if needed) at step 502. Next, the digital asset source address is added to an existing list in a memory 24 (FIG. 1) of apparatus 22 (FIG. 1) at step 504.

Next, existing values for each digital asset address in existing list 502 are retrieved.

Next, values from each digital asset source may be updated in step 322.

Next digital asset type, values, and the date/time are updated in memory 24 (FIG. 1) of apparatus 22 (FIGS. 1 and 2).

Next, an updated display value is calculated based on aggregated values 328.

Next the display value in display 10 (FIGS. 1 and 2) is updated at step 330.

Next, the time is reset at step 412, for the next update 414.

Referring now to FIG. 6, a simplified logical diagram of the apparatus 22 (FIGS. 1 and 2) is shown in accordance with aspects of the present disclosure.

In general, as shown in FIG. 1, apparatus 22 is configured with a logic circuit 12 logically coupled to display driver 14, power source 20, memory 24, a connector 16. Display driver 14 is further logically coupled to display 10.

As shown in FIG. 6, encryption and key manager 608, coupled to memory 24 (FIG. 1), is configured to generate a digital asset address from a public digital asset key 502. Value reader 610 is configured to update in memory 24 (FIG. 1) the digital asset type, values, and date/time 326.

Digital asset value reader 610 is further logically coupled to connector 16 (FIG. 1) and is configured to refresh digital asset values. Connector 16 (FIG. 1) is further logically coupled to the digital asset 18 (FIG. 1), which may comprise one or more of a server of other device accessible via the Internet, or an otherwise coupled node or set of digital asset wallets, for example.

FIG. 7 shows a representative diagram of a one-way hash function that may be used with digital assets such as Bitcoin. In general, a private key 702 may be generated that may be further used to generate a single public key 706 via a one-way hash function which, in turn, may be used to generate a set of digital asset addresses, such as a Bitcoin address 712. In general, it is computationally difficult to reverse the calculation as can be seen in step 710 or step 706.

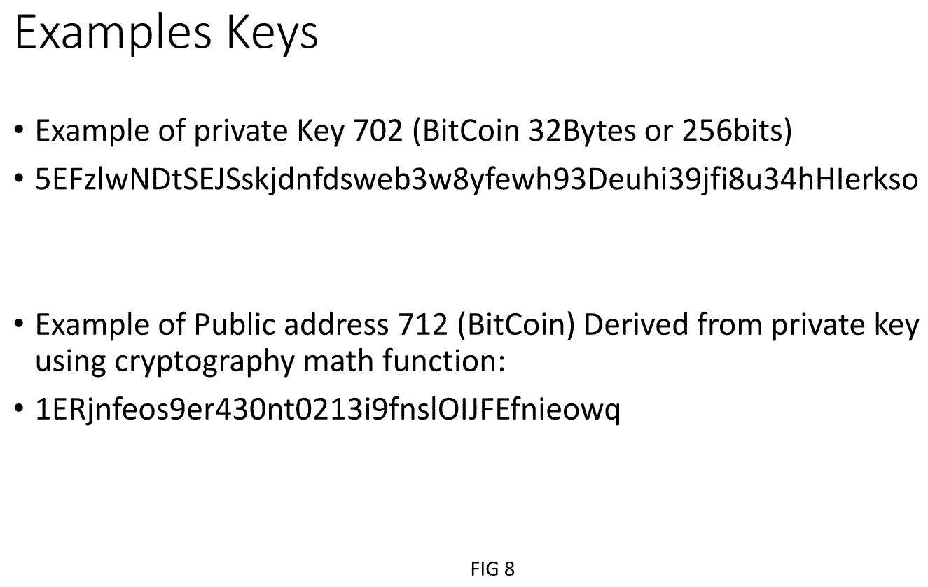

Referring now to FIG. 8, an example of a private Bitcoin key and Bitcoin public address usable in accordance with various aspects of the present disclosure are shown

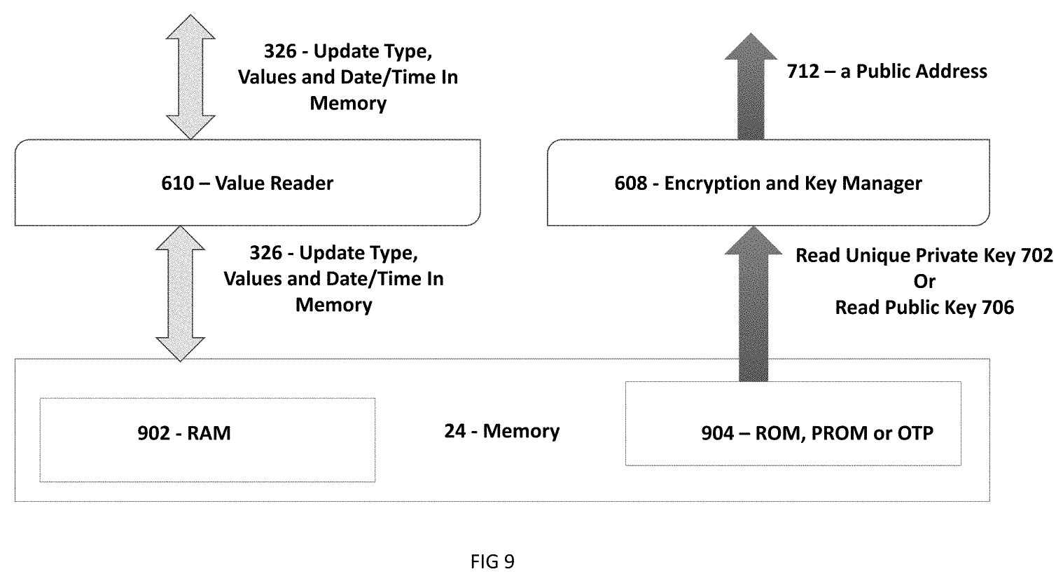

FIG. 9 shows a representative diagram illustrating how a specialized memory, such as at least one of a Read Only Memory (ROM), Programmable Read Only Memory (PROM), One Time Programmable Read Only Memory (OTP), or Random Access Memory (RAM) 904, can be utilized to store and/or otherwise use a Private Key 702 and Public Key 706. Encryption and key manager 608 can access these values directly or indirectly to derive the Public address 712.

In one embodiment, encryption and key manager 608 can be so tightly coupled with the ROM 904 that the private key 702 become inaccessible externally. In such embodiment, any values transferred to the public address 712 corresponding to the inaccessible private key 702 will be forever trapped in the apparatus 22. This feature will allow the apparatus 22 to forever hold on to the value of the digital currency transferred into it, for example.

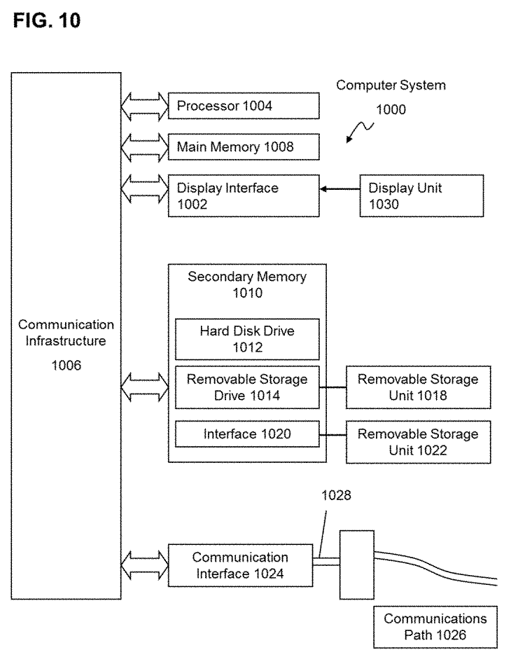

Aspects of the present disclosure may be implemented using hardware, software, or a combination thereof and may be implemented in one or more computer systems or other processing systems. In an aspect of the present disclosure, features are directed toward one or more computer systems capable of carrying out the functionality described herein. An example of such a computer system 1000 is shown in FIG. 10.

Computer system 1000 includes one or more processors, such as processor 1004. The processor 1004 is coupled to a communication infrastructure 1006 (e.g., a communications bus, cross-over bar, or network). Various software aspects are described in terms of this example computer system. After reading this description, it will become apparent to a person skilled in the relevant art(s) how to implement aspects hereof using other computer systems and/or architectures.

Computer system 1000 may include a display interface 1002 that forwards graphics, text, and other data from the communication infrastructure 1006 (or from a frame buffer not shown) for display on a display unit 1030. Computer system 1000 may include a main memory 1008, preferably random access memory (RAM), and may also include a secondary memory 1010. The secondary memory 1010 may include, for example, a hard disk drive 1012 and/or a removable storage drive 1014, e.g., an optical disk drive. The removable storage drive 1014 may read from and/or write to a removable storage unit 1018 in a well-known manner. As will be appreciated, the removable storage unit 1018 may include a computer readable storage medium having stored therein computer software and/or data.

Alternative aspects of the present disclosure may include secondary memory 1010 and may include other similar devices for allowing computer programs or other instructions to be loaded into computer system 1000. Such devices may include, for example, a removable storage unit 1022 and an interface 1020. Examples of such may include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, which allow software and data to be transferred from the removable storage unit 1022 to computer system 1000.

Computer system 1000 may also include a communications interface 1024. Communications interface 1024 may allow software and data to be transferred among computer system 1000 and external devices. Examples of communications interface 1024 may include a modem, a network interface (such as an Ethernet card), a communications port, a Personal Computer Memory Card International Association (PCMCIA) slot and card, etc. Software and data transferred via communications interface 1024 may be in the form of signals 1028, which may be electronic, electromagnetic, optical or other signals capable of being received by communications interface 1024. These signals 1028 may be provided to communications interface 1024 via a communications path (e.g., channel) 1026. This path 1026 may carry signals 1028 and may be implemented using wire or cable, fiber optics, a telephone line, a cellular link, a radio frequency (RF) link and/or other communications channels. As used herein, the terms “computer program medium” and “computer usable medium” refer generally to media such as a removable storage drive 1014, a hard disk installed in hard disk drive 1012, and/or signals 1028. These computer program products may provide software to the computer system 1000. Aspects of the present disclosure are directed to such computer program products.

Computer programs (also referred to as computer control logic) may be stored in main memory 1008 and/or secondary memory 1010. Computer programs may also be received via communications interface 1024. Such computer programs, when executed, may enable the computer system 1000 to perform the features in accordance with aspects of the present disclosure, as discussed herein. In particular, the computer programs, when executed, may enable the processor 1004 to perform the features in accordance with aspects of the present disclosure. Accordingly, such computer programs may represent controllers of the computer system 1000.

Where aspects of the present disclosure may be implemented using software, the software may be stored in a computer program product and loaded into computer system 1000 using removable storage drive 1014, hard disk drive 1012, or interface 1020. The control logic (software), when executed by the processor 1004, may cause the processor 1004 to perform the functions described herein. In another aspect of the present disclosure, the system may be implemented primarily in hardware using, for example, hardware components, such as application specific integrated circuits (ASICs). Implementation of the hardware state machine so as to perform the functions described herein will be apparent to persons skilled in the relevant art(s). In yet another variation, aspects of the present disclosure may be implemented using a combination of both hardware and software.

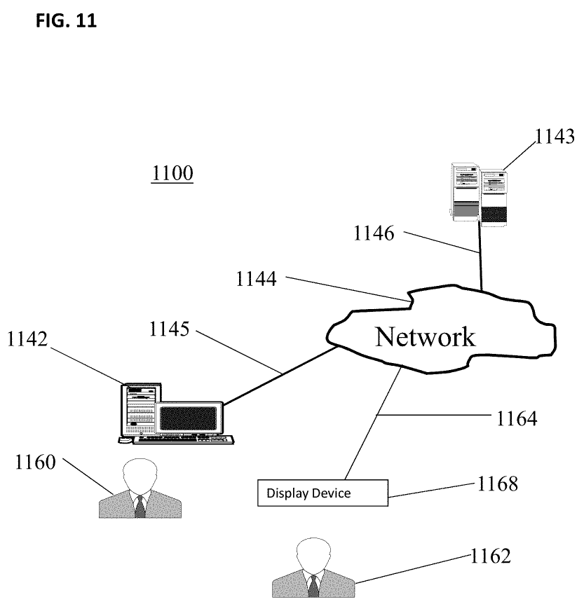

FIG. 11 shows a communication system 1100 usable with various features in accordance with aspects of the present disclosure. The communication system 1100 includes one or more accessors 1160, 1162 (also referred to interchangeably herein as one or more “users”) and one or more terminals 1142, 1168, such as the display device 22 shown and described with respect to FIGS. 1-9. In one aspect of the present disclosure, data for use is, for example, input and/or accessed by accessors 1160, 1162 via terminals 1142, 1168, such as device 22 of FIGS. 1-9, personal computers (PCs), minicomputers, mainframe computers, microcomputers, telephonic devices, or wireless devices, personal digital assistants (“PDAs”) or a hand-held wireless devices (e.g., wireless telephones) coupled to a server 1143, such as a PC, minicomputer, mainframe computer, microcomputer, or other device having a processor and a repository for data and/or connection to a repository for data, via, for example, a network 1144, such as the Internet or an intranet, and/or a wireless network, and couplings 1145, 1146, 1164. The couplings 1145, 1146, 1164 include, for example, wired, wireless, or fiberoptic links. In another aspect of the present disclosure, the method and system of the present disclosure may include one or more features that operate in a stand-alone environment, such as on a single terminal.

While the foregoing disclosure discusses example aspects and/or features, it should be noted that various changes and modifications could be made herein without departing from the scope of the described aspects and/or features as defined by the appended claims. Furthermore, although elements of the described aspects and/or features may be described or claimed in the singular, the plural is contemplated unless limitation to the singular is explicitly stated. Additionally, all or a portion of any aspect and/or embodiment may be utilized with all or a portion of any other aspect and/or feature, unless stated otherwise.

What is claimed is:

1. An apparatus for presenting a value of digital assets, the apparatus comprising:
a digital asset reader configured to receive one or more current values associated with at least one digital asset;
a microcontroller configured to perform a calculation using the one or more current values to determine a value of the at least one digital asset;
a human interface configured to select a display that represents the value of the at least one digital asset from a plurality of predefined displays, where each of the plurality of predefined displays represents a different value of digital assets, and present the display.

2. The apparatus of claim 1, wherein the microcontroller is further configured to:
determine a digital asset type for the at least one digital asset; and
aggregate the one or more current values based at least on the digital asset type to determine the value of the at least one digital asset.

3. The apparatus of claim 1, wherein the human interface is configured to select the display from the plurality of predefined displays when the value of the at least one digital asset is within a range of values associated with the display.

4. The apparatus of claim 1, wherein the microcontroller is further configured to perform a revised calculation of the one or more current values after a predetermined period of time; and
the human interface is further configured to select the display using the revised calculation of the value.

5. The apparatus of claim 1, wherein the display includes one or more of glowing, flashing, pulsing, changing color, vibrating, color changing in intensity, fading in, fading out, changing brightness, changing hues, electronic ink, electronic paper, haptic feedback, or an aural representation.

6. The apparatus of claim 1, wherein the at least one digital asset is one or more of a cryptocurrency, fiat currency, stocks, bonds, mutual funds, real estate holdings, savings accounts, or securities.

7. The apparatus of claim 1, further comprising:
a memory storage unit configured to securely store the at least one digital asset.

8. The apparatus of claim 1, wherein the at least one digital asset is stored in a digital wallet or an account remote from the apparatus.

9. The apparatus of claim 1, wherein the digital asset reader is further configured to:
verify a source of a digital asset address associated with the at least one digital asset using a public key associated with the digital asset address; and
update the one or more current values associated with the at least one digital asset when the source of the digital asset address is verified.

10. The apparatus of claim 1, further comprising:
a memory storage unit configured to securely store an externally inaccessible private key in the apparatus for at least one digital asset; and
an encryption and key manager configured to associate the externally inaccessible private key with the at least one digital asset public key or public address.

11. A method for presenting a value of digital assets executed by an apparatus comprising a processor and a memory, the method comprising:
receiving one or more current values associated with at least one digital asset;
performing a calculation using the one or more current values to determine a value of the at least one digital asset;
selecting a display that represents the value of the at least one digital asset from a plurality of predefined displays, where each of the plurality of predefined displays represents a different value of digital assets; and
transmitting the display for presentation.

12. The method of claim 11, wherein the calculation further comprises:
determining a digital asset type for the at least one digital asset; and
aggregating the one or more current values based at least on the digital asset type to determine the value of the at least one digital asset.

13. The method of claim 11, wherein the display is selected from the plurality of predefined displays when the value of the at least one digital asset is within a range of values associated with the display.

14. The method of claim 11, further comprising:
performing a revised calculation of the one or more current values after a predetermined period of time; and
selecting the display using the revised calculation of the value.

15. The method of claim 11, wherein the display includes one or more of glowing, flashing, pulsing, changing color, vibrating, color changing in intensity, fading in, fading out, changing brightness, changing hues, electronic ink, electronic paper, haptic feedback, or an aural representation.

16. The method of claim 11, wherein the at least one digital asset is one or more of a cryptocurrency, fiat currency, stocks, bonds, mutual funds, real estate holdings, savings accounts, or securities.

17. The method of claim 11, wherein the at least one digital asset is securely stored in one of the apparatus or an account remote from the apparatus.

18. The method of claim 11, wherein receiving the one or more current values associated with the at least one digital asset further comprises:
verifying a source of a digital asset address associated with the at least one digital asset using a public key associated with the digital asset address; and
updating the one or more current values associated with the at least one digital asset when the source of the digital asset address is verified.

19. The method of claim 11, wherein the method further comprises:
storing an externally inaccessible private key in the apparatus for at least one digital asset; and
associating the externally inaccessible private key for at least one digital asset with at least a public key or public address.

20. The method of claim 11, wherein the method further comprises:
receiving, at a digital wallet on the apparatus, an amount of cryptocurrency;
associating an externally inaccessible private key securely embedded in the apparatus with the amount of cryptocurrency; and
securely storing the amount of cryptocurrency.
